(19) United States
(12) Patent Application Publication
(10) Pub. No.: US 2009/0083667 A1
(43) Pub. Date: Mar. 26, 2009

(54) IMAGING APPARATUS AND METHOD FOR CONTROLLING THE SAME

(75) Inventors: Yoshihide UCHIDA, Hino-shi (JP); Toyokazu AIZAWA, Sagamihara-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/200,767

(22) Filed: Aug. 28, 2008

(30) Foreign Application Priority Data
Sep. 21, 2007 (JP) 2007-245208

(51) Int. Cl. G06F 3/048

(52) U.S. Cl. 715/835

(57) ABSTRACT

According to one embodiment, an imaging apparatus according to one embodiment of the invention has an image taking part, an image data processor, a display part, a storage part, and a controller. The controller displays a curved band-like image, which is a part of a ring shape, in a left side region of the display part, and displays a menu-type identification icon image for identification of a present menu as a taking menu, a reproduction menu, or a set-up menu in an inside region, which is provided on the left side of the curved band-like region. The controller has a display parts selector for arranging a plurality of menu item icon images, which correspond to the menu-type identification icon image being displayed, and an icon image for set-up on the curved band-like image.

### CROSS-REFERENCE TO RELATED APPLICATIONS

This application is based upon and claims the benefit of priority from Japanese Patent Application No. 2007-245208, filed Sep. 21, 2007, the entire contents of which are incorporated herein by reference.

### BACKGROUND

1. Field

One embodiment of the present invention relates to an imaging apparatus and a method for controlling the same. Particularly, the invention relates to an imaging apparatus which displays a menu in an easily understandable manner for a user such that the user can easily understand which of taking, reproduction, and set-up menus is being displayed.

2. Description of the Related Art

An imaging apparatus has a menu display function. It is possible to transfer from a state in which the entire menu is displayed to a taking menu, a reproduction menu, set-up menu, or other menu in a display part. After transferring to a predetermined menu display, a user can select a desired menu item from a plurality of menu items and set a function corresponding to the selected menu item (for example, Jpn. Pat. Appln. KOKAI Publication Nos. 2006-191300 and 2006-148874).

In the taking menu and the reproduction menu, the same icon (for example, image deletion icon) may appear. In addition, since there are many setting items in both the taking menu and the reproduction menu, the user may not be sure which of the taking menu, the reproduction menu, and the set-up menu is presently displayed. Further, when the user wants to change a set-up when taking or reproducing images, since the user is required to return to an initial basic menu, there is a problem that the operation is troublesome.

The user may adjust or set an unnecessary function, or may perform erroneous operation in adjustment or setting of a necessary function. Therefore, an imaging apparatus which provides better operability and realizes the prevention of the erroneous operation and adjustment has been required.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are explanatory views showing an outline of an imaging apparatus to which this invention is applied;

FIG. 2 is a diagram showing the electrical function blocks of the imaging apparatus in FIG. 1;

FIG. 3 is a diagram showing the function block of a controller in FIG. 2;

FIG. 4 is an explanatory view showing a state in which a reproduction menu is displayed in a reproducing mode;

FIG. 5 is an explanatory view showing kinds of menu items which can be adjusted or set when the reproduction menu is displayed;

FIG. 6 is an explanatory view showing a state in which a taking menu is displayed in a taking mode;

FIG. 7 is an explanatory view showing kinds of menu items which can be adjusted or set when the taking menu is displayed;

FIG. 8 is an explanatory view showing a state in which a set-up menu is displayed in a set-up mode;

FIG. 9 is an explanatory view showing kinds of menu items which can be adjusted or set when the set-up menu is displayed;

FIG. 10 is an explanatory view for explaining the transfer of a cursor in a case in which a multifunction button 2103 is operated when a menu is displayed; and

FIG. 11 is an explanatory view showing a simple operation flow until a menu item is displayed in the imaging apparatus according to this invention,

### DETAILED DESCRIPTION

Various embodiments according to the invention will be described hereinafter with reference to the accompanying drawings.

One embodiment of this invention provides an imaging apparatus which displays a menu in a display part in an easily understandable manner for a user and is effective to prevent erroneous adjustment and operation to a menu item, and a method for controlling the imaging apparatus.

In order to solve the above problems, in an embodiments of this invention, the imaging apparatus has an image data processor for processing image data which has been obtained in an image taking part, a display part for displaying image data which has been processed in the image data processor, a storage part for storing image data which has been processed in the image data processor, and a controller for controlling the image taking part, the image data processor, the display part, and the storage part.

The controller displays a curved band-like image, which is a part of a ring shape, in a left side region of the display part, and displays a menu-type identification icon image for identification of a present menu as a taking menu, a reproduction menu, or a set-up menu in an inside region on the left side of the curved band-like image. The controller has a display parts selector for arranging a plurality of menu item icon images and icon images for set-up on the curved band-like image. The plurality of menu item icon images correspond to the menu-type identification icon images being displayed.

According to the above means, when the menu item icon image is selected, and a function corresponding to the menu item is adjusted or set, the menu-type identification icon image for identification of the menu as the taking menu, the reproduction menu, or the set-up menu is displayed, whereby it is possible to improve the reliability of the imaging apparatus without the erroneous operation.

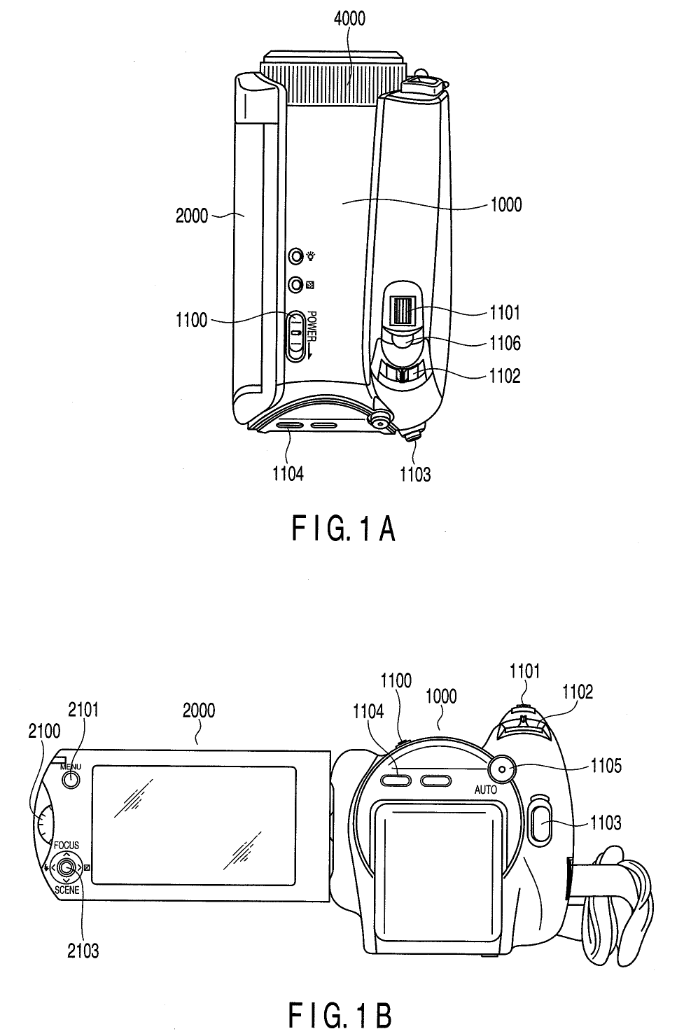

Hereinafter, the embodiment of this invention is explained in more detail with reference to the drawings. FIG. 1 shows an outline of a high definition video camera, which is an imaging apparatus to which this invention is applied. The high definition video camera can take a moving image and a still image.

FIG. 1A is an overhead view of the high definition video camera. FIG. 1B shows the high definition video camera as viewed from the back side. As shown in FIGS. 1A and 1B, the high definition video camera is provided with an imaging apparatus body 1000, a display panel 2000, and a lens part 4000.

The imaging apparatus body 1000 is provided with a power switch 1100, a zoom lever 1101, imaging/reproducing switching button 1102, an imaging button 1103, a chapter button 1104, and auto setting button 1105.

The power switch 1100 is used for switching a state of the power source of the high definition video camera. The zoom lever 1101 is used for adjusting a focal length of the lens part 4000. The imaging/reproducing switching button 1102 is used for switching an operation mode of the high definition video camera to a taking mode for taking images or a reproducing mode for reproducing imaging data stored in the apparatus. The imaging button 1103 is used for recording the images when the operation mode of the high definition video camera is in the taking mode. The chapter button 1104 is used for setting chapter units in the imaging data. The auto setting button 1105 is used for automatically performing various kinds of settings such as sensitivity and brightness when the images are taken. Reference numeral 1106 is a button for taking a still image.

The display panel 2000, which is a display part of the high definition video camera, is attached to the imaging apparatus body 1000 in an openable manner. The display panel 2000 is normally accommodated in a recessed portion of the imaging apparatus body 1000, and is opened as shown in FIG. 1B at the usage. The display panel 2000 can be rotated about its longitudinal direction as the axis. The display panel 2000 is provided with a liquid crystal monitor. The liquid crystal monitor displays thereon the images taken by the high definition video camera, and is constituted of a high definition screen with an aspect ratio of 16:9. The outer frame of the liquid crystal monitor of the display panel 2000 has a jog dial 2100, a menu button 2101, and a multifunction button 2103.

The jog dial 2100 is operated to select various functions and is constituted of a rotatable dial, for example. The menu button 2101 is operated to display various menus on the liquid crystal monitor. The multifunction button 2103 includes a cross-key function and can realize the operation of selection of the various functions. The multifunction button 2103 can be pressed in the up and down directions and the left and right directions, for example. In addition, the multifunction button 2103 includes an OK button function for confirming the operation of selection of the various functions, and is provided at the center of the cross key. Note that the menu button 2101, the jog dial 2100 and the multifunction button 2103 are provided close to each other, whereby the OK button can be easily operated after the jog dial 2100 has been operated. The imaging apparatus body 1000 is held stably by the right hand, the frame of the display panel 2000 is held by the left hand, and the menu button 2101, the jog dial 2100 and the multifunction button 2103 can be arbitrarily selected to be operated by the left thumb, whereby the excellent operability can be provided.

The lens part 4000 is used for taking images, and has an imaging lens for receiving the light of images.

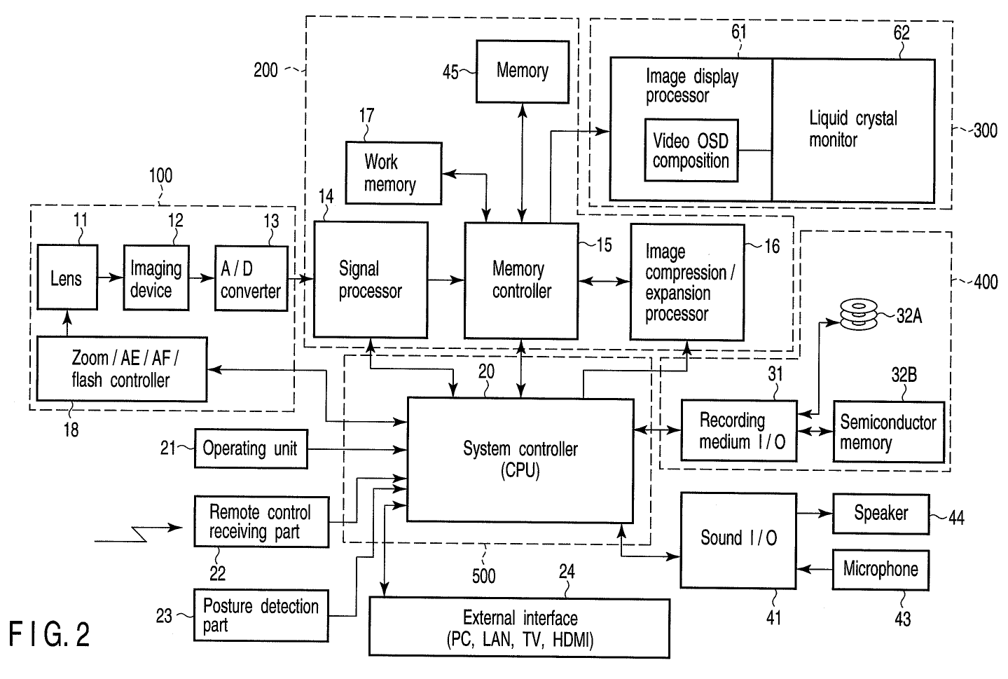

FIG. 2 is a diagram showing the optical and electrical systems of the above high definition video camera. The high definition video camera is provided with an image taking part 100, a signal processor 200, a display part 300, a storage part 400, and a controller 500.

The image taking part 100 is provided with a lens 11, an imaging device 12, an analog/digital (A/D) converter 13, and a controller 18. A subject image taken from the lens 11 is formed on an imaging surface of the imaging device 12 (for example, CCD imaging device). The subject image is converted into an electrical signal in the imaging device 12 to be converted to a digital signal (video data) by the analog/digital (A/D) converter 13, and thus to be input in the post stage of the signal processor 14. The controller 18 in an imaging part can perform zoom adjustment, automatic iris adjustment (AE), automatic focus adjustment (AF), flash control, and the like, in response to a control signal from the controller 500.

The signal processor 200 is provided with a signal processor 14, a memory controller 15, image compression/expansion processor 16, a work memory 17, and a memory 45. The signal processor 14 performs gamma correction, color signal separation, white balance adjustment, and the like, in response to the digital signal of the subject image from the image taking part 100. When a photographing start operation (shutter operation) is not performed in a normal photographing state, the video data from the signal processor 14 is input into an image display processor 61 through the memory controller 15. When the photographing start operation (shutter operation) is performed, the video data is subjected to image compression (for example, compression by JPEG method) in the image compression/expansion processor 16, to be stored in the storage part 400.

The work memory 17 is used, for example, when the image data is edited, a thumbnail image is created, and the order of images is changed. The work memory 17 is further used for editing various icons. The work memory 17 can store the image data of one or a plurality of screens. The video data stored in the work memory 17 is input into the image display processor 61 through the memory controller 15.

A display part 300 is provided with the image display processor 61 and a liquid crystal monitor 62. The image display processor 61 performs conversion processing for displaying the received video data on the liquid crystal monitor 62, and performs composition of video and OSD for synthesizing various display parts (for example, icons) such as menus, and supplies the video data to the liquid crystal monitor 62. The liquid crystal monitor 62 sequentially displays the received video data. Thereby, the image being imaged or the subject image desired to be imaged in a standby state is displayed on the liquid crystal monitor 62.

The storage part 400 is provided with a storage medium input/output (I/O) 31. A hard disk (HD) 32A or a storage medium such as a semiconductor memory 32B is mounted in the storage medium I/O 31. The video data is stored in the storage medium mounted in the storage medium I/O 31, on the basis of the control by the controller 500. When the video data stored in the storage medium, which is mounted in the storage medium I/O 31, is read out on the basis of the control by the controller 500, the video data is processed to be expanded in the image compression/expansion processor 16, and input into the image display processor 61 through the memory controller 15. Namely, the reproduction image is displayed on the liquid crystal monitor 62. Note that as a recording medium, an optical disk (DVD), for example, may be used in addition to the above mentioned one.

The controller 500 is provided with a system controller 20. The system controller 20 controls the overall operation of the high definition video camera, and is constituted of a CPU, a buffer memory such as a RAM functioning as a work area of the CPU, and a program memory such as a ROM in which various programs to be performed by the CPU and control data are stored In the system controller 20, the CPU performs the programs stored in the program memory to realize various functions.

The high definition video camera is provided with an operating unit 21, a remote control receiver 22, a posture detector 23, an external interface 24, a sound I/O 41, a microphone 43, and a speaker 44.

The operating unit 21 is used for receiving the operation input from the outside, and is a generic name of the various buttons shown in FIG. 1 or a switch. The remote control receiver 22 is used for receiving the operation input by an external remote controller (not shown). The controller 500 controls the operation inputs received from the operating unit 21 and the remote control receiver 22 so as to reflect the operation inputs to the entire apparatus.

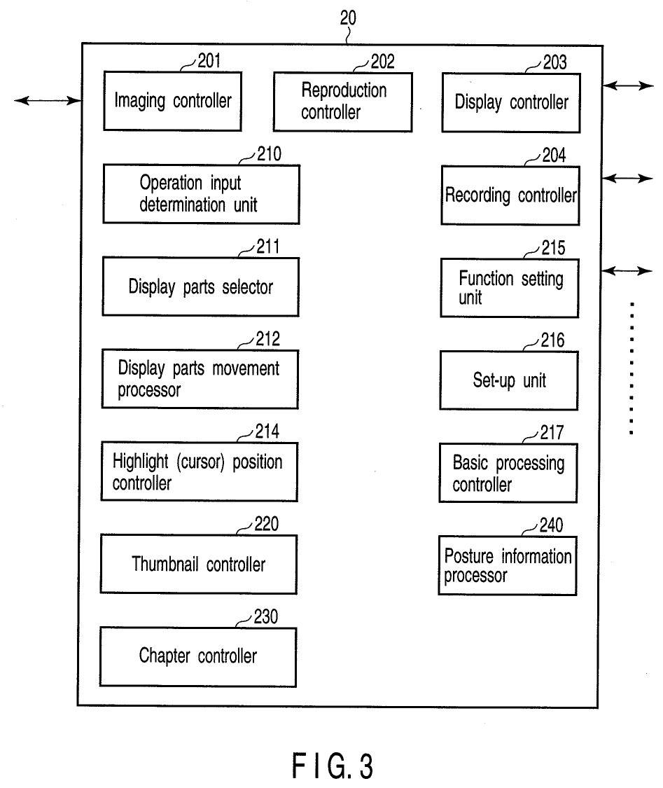

FIG. 3 shows the functions of the system controller 20. An imaging controller 201 sets the taking mode in accordance with the operation input and controls each part for the purpose of taking picked-up image data. A reproduction controller 202 sets the reproducing mode in accordance with the operation input. The display controller 203 displays image data for display sent from the signal processor 200. A recording controller 204 controls each part such that the picked-up image data is compressed in the signal processor 200 to be recorded in a selected recording medium. An operation input determination unit 210 analyzes and determines an operation signal input from the operating unit 21 or the remote control receiver 22.

A display parts selector 211 selects an arbitrary display part (such as an icon and a mark) to be displayed on a menu screen or the like. The various display parts are stored in a memory or the image display processor 61.

A display parts movement processor 212 controls the movement and deletion of the display part in response to the operation input. A highlight (cursor) position controller 214 controls a display position of a highlight position (cursor position) in response to the operation input. A function setting unit 215 sets various functions in the imaging apparatus in cooperation with a set-up unit 216. A basic processing controller 217 controls basic operation functions such as data transferring, reading, timing setting, and the like. A thumbnail controller 220 controls creation of a thumbnail, display output, scrolling, and the like. A chapter controller 230 has a chapter management function. The chapter controller 230 generates a chapter, sets a representative image of the chapter, and creates a small image of the representative image. A posture information processor 240 processes information from the posture detector 23 to display a reference image as a horizontal reference on a screen, or to change the density of the reference image in accordance with the inclined state.

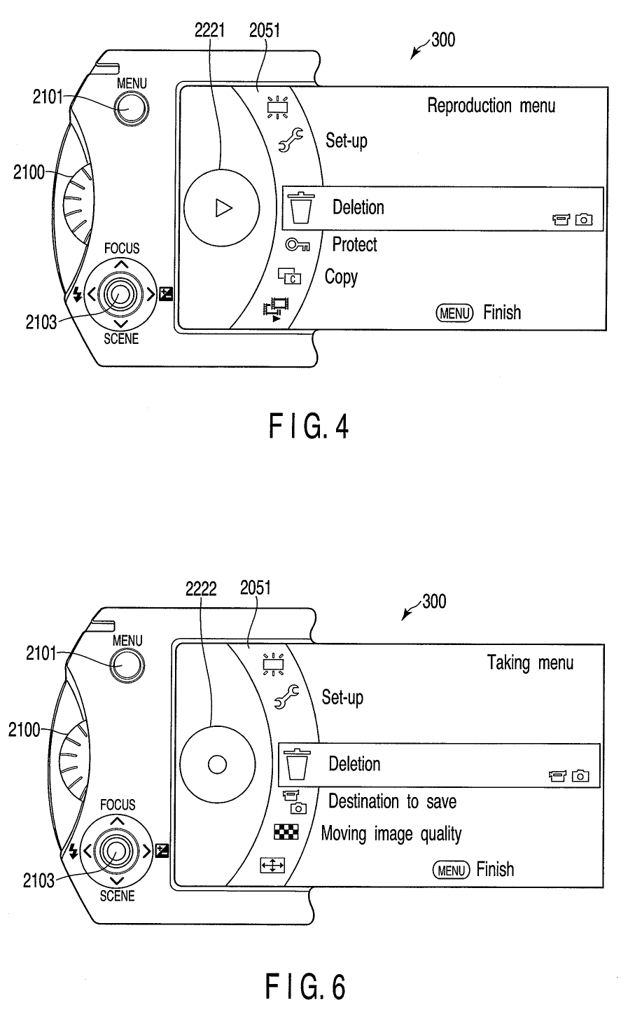

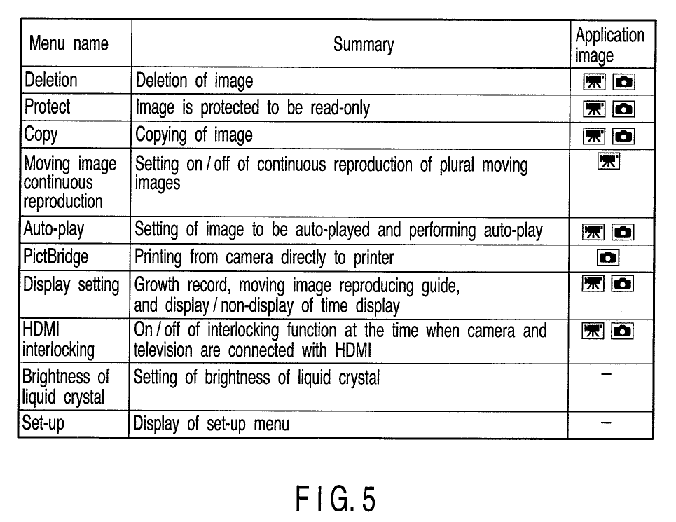

FIG. 4 shows a state in which the reproduction menu is displayed in the reproducing mode. FIG. 5 shows kinds of menu items which can be adjusted or set when the reproduction menu is displayed.

The imaging/reproducing switching button 1102 is set to the reproducing mode, and the menu button 2101 of the display part 300 is then pushed, whereby it is possible to transfer to the state in which the reproduction menu is displayed as shown in FIG. 4. At that time, a mark (design image for representing the kind of a menu) representing the reproducing mode is displayed in the inside of a curved band-like image 2051. A plurality of menu item icons which can be adjusted or set in the reproducing mode are arranged on the curved band-like image 2051. A description of each menu item icon is displayed on the right side of each of the icons. The jog dial 2100 is rotated or the upper or lower side of the multifunction button 2103 is pushed, whereby the positions of the plurality of menu item icons can be rotated with the curved band-like image 2051. It is possible to select a menu item corresponding to the icon positioned at the center of the curved band-like image 2051 (the icon representing “DELETION” is positioned at the center in the example in FIG. 4). In this state, when the multifunction button 2103 is pushed, a plurality of thumbnails of a program or a chapter, which are a target to be deleted, are displayed. The cursor is moved to the position of the thumbnail, which is desired to be deleted, to push the multifunction button 2103, whereby the target program or chapter can be deleted.

The above mentioned menu items are described on the left side of FIG. 5, while the summaries of the menu items are described on the right side.

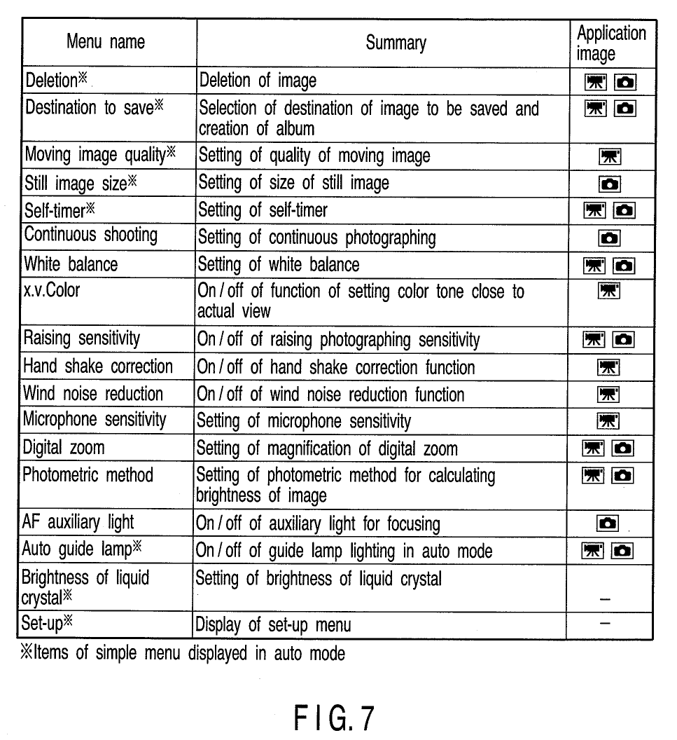

FIG. 6 shows a state in which the taking menu is displayed in the taking mode. FIG. 7 shows kinds of the menu items which can be adjusted or set when the taking menu is displayed.

The imaging/reproducing switching button 1102 is set to the taking mode, and the menu button 2101 of the display part 300 is then pushed, whereby it is possible to transfer to the state in which the taking menu is displayed as shown in FIG. 6. At that time, a mark (design image for representing the kind of a menu) representing the taking mode is displayed in the inside of the curved band-like image 2051. A plurality of the menu item icons which can be adjusted or set in the taking mode are arranged on the curved band-like image 2051. A description of each menu item icon is displayed on the right side of each of the icons. The jog dial 2100 is rotated or the upper or lower side of the multifunction button 2103 is pushed, whereby the positions of the plurality of menu item icons can be rotated with the curved band-like image 2051. It is possible to select a menu item corresponding to the icon positioned at the center of the curved band-like image 2051 (the icon representing “DELETION” is positioned at the center in the example in FIG. 6). In this state, when the multifunction button 2103 is pushed, a plurality of thumbnails of a program or a chapter, which are a target to be deleted, are displayed. The cursor is moved to the position of the thumbnail, which is desired to be deleted, to push the multifunction button 2103, whereby the target program or chapter can be deleted.

The menu items are described on the left side of FIG. 7, while the summaries of the menu items are described on the right side.

The icon of a set-up item can be displayed in both the reproduction menu and the taking menu. Therefore, it is possible to shift to the set-up mode from both the taking mode and the reproducing mode.

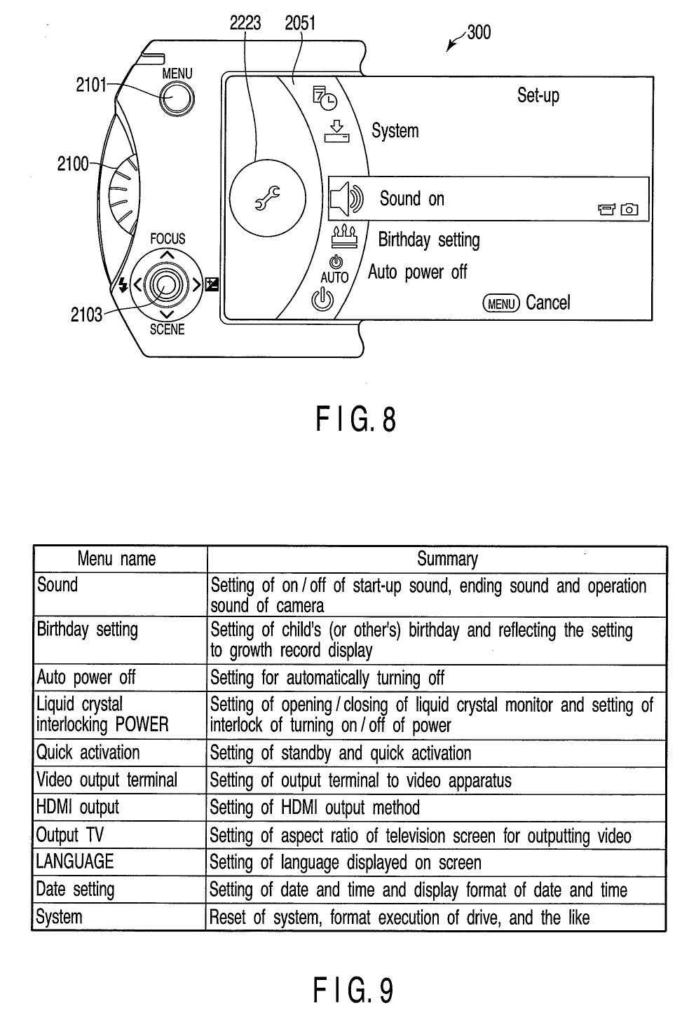

FIG. 8 shows a state in which a set-up menu is displayed in the set-up mode. FIG. 9 shows kinds of the menu items which can be adjusted or set when the set-up menu is displayed. The menu items are described on the left side of FIG. 9, while the summaries of the menu items are described on the right side.

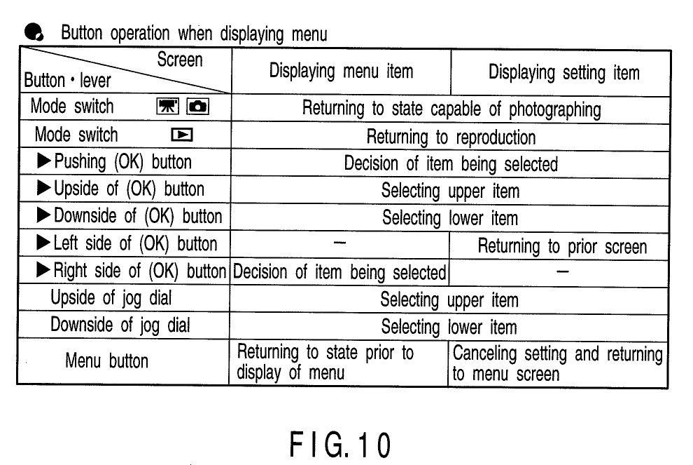

FIG. 10 is an explanatory view for explaining the transfer of the cursor in a case in which the multifunction button 2103 is operated when the menu is displayed.

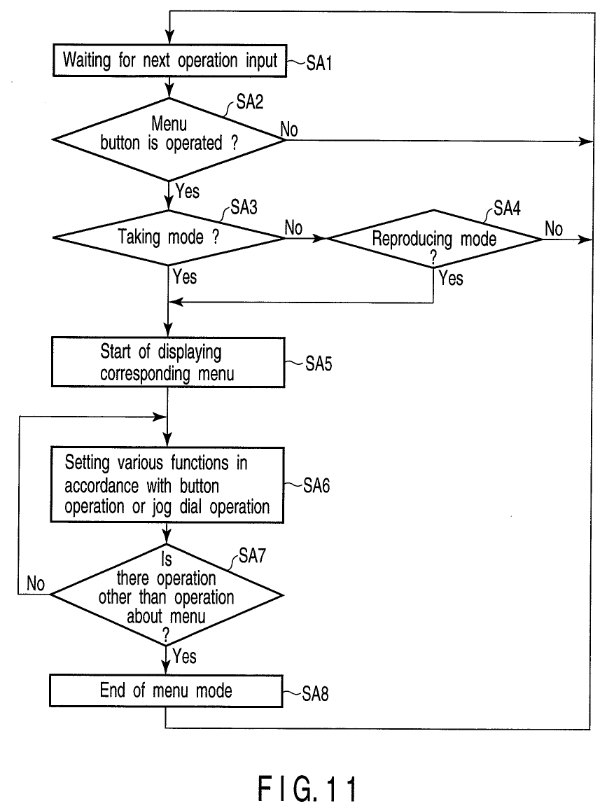

FIG. 11 shows a simple operation flow until the menu item is displayed in the imaging apparatus according to this invention. When the operation input is provided, the determination of whether the menu button has been operated is performed (steps SA1 and SA2). When it has been determined that the menu button was pushed, the present mode is determined as the taking mode or the reproducing mode (steps SA3 and SA4). When the operation mode is either of the taking mode and the reproducing mode, the menu corresponding to a menu-type identification icon, which corresponds to each mode, is displayed (step SA5, and FIG. 4 or FIG. 6).

When the menu is displayed, various functions are set in response to the button operation or the jog dial operation (step SA6). If an operation other than the operation concerning a menu is performed (step SA7), the menu mode is finished (step SA8).

According to the imaging apparatus of this invention, when the menu is displayed, the menu-type identification icon for identification of the present menu as the taking menu, the reproduction menu, or the set-up menu, is displayed in an inside region on the left side of the curved band-like image 2051, while the plurality of menu item icon images corresponding to the displayed menu-type identification icon image and the icon image for set-up are arranged on the curved band-like image 2051. Such an operation is performed mainly by a control flow in the display parts selector 211.

The menu-type identification icon image is kept displayed while a user selects the menu item to adjust or set the menu item. Thus, the user can easily recognize the purpose of the menu item being adjusted or set by the user.

The imaging apparatus of this invention is further described. In this apparatus, when the still image or moving image recorded in a hard disk or a memory card is transferred or received to or from an external apparatus, the still image can be transferred or received to or from a USB terminal through a USS controller. This case assumes that the external apparatus is a personal computer. It is also possible to transfer or receive an MPEG compressed moving image directly to or from an image recording/reproducing apparatus such as a DVD recorder through an interface. In general, when such image data is transferred to the DVD recorder, the MPEG compressed moving image is decoded on a camera side, and the resulting analog signal is output through a video terminal or S-terminal. The analog signal is re-compressed on the image recording/reproducing apparatus side to be stored. With this method, for example, it takes one hour to record the moving image recorded for one hour in the DVD recorder. However, in this case, the MPEG compressed moving image data can be transferred in a streaming form to the DVD recorder through a network as it is. Although the transfer time depends on a compression rate, it is possible to realize a speed of several tens of times faster than that of real time, and a high image quality can be maintained because re-encoding is not executed. For example, when the transfer time is 10 times faster than real time, it takes only six minutes to record the moving image recorded for one hour in the DVD recorder. When a LAN is used as a network, the moving image is sent or received to or from a LAN terminal through a LAN controller. In addition to the moving image data, the data containing the still image or audio data may be transferred to the DVD recorder.

As mentioned above, when the recording medium is a large capacity hard disk, since the number of recorded images is increased, it is necessary to feed or return the images at high speed. Therefore, in order to perform the feeding and returning of the images with no stress, the jog dial is used. The jog dial gives information of the rotation angle and rotation speed thereof to the controller for controlling the entire system. The controller may control the display speed of the image based on the information from the jog dial.

According to this invention, menu icons on the screen of the display part 300 are arranged concentrically in the jog dial. The iconized menu items are displayed on the screen. These icons are visually arranged concentrically in the jog dial. When the jog dial is rotated, the icons of the menu items are also rotated in synchronism with the rotation of the jog dial. The design representing the jog dial is provided between the jog dial and the icon items, whereby a user can intuitively understand that the menu can be selected or changed by rotating the jog dial.

When the difference of rotation radius is generated between the jog dial and the menu item icons, the user may feel that the rotation of the menu item icons is too fast or slow with respect to the rotation of the jog dial. In this invention, the user can set the relation of the rotation speeds of the jog dial and the menu item icons.

The user rotates the jog dial to select the setting of the rotation speed of the menu item icons from a menu on the screen. For example, the user selects “icon rotation speed” in the set-up menu, whereby he can select the items such as “faster”, “fast”, “intermediate”, “slow”, and “slower”, to set the rotation speed. The user confirms the selected result by rotating the jog dial. If the user does not like the rotation speed, he can change the setting to select a suitable speed. The controller stores the setting, and controls the rotation of the menu item icons on the basis of the input of the jog dial and the setting value.

In addition, the menu-type identification icon (design) representing the kind of menu is displayed, whereby the user can easily understand the kind of the menu being displayed.

The jog dial and the curved band-like image are concentrically arranged, and their rotations are synchronized, whereby the usability and the operational feeling are improved. The design representing the jog dial is displayed, whereby the user can intuitively understand that the menu can be selected or changed by rotating the jog dial. In addition, the design representing the kind of the menu is displayed, whereby the user can easily understand the kind of the menu.

This invention is not limited to the above-described embodiment as such, and the components of this invention can be modified and embodied without departing from the scope in an execution stage. Further, various inventions can be formed by appropriately combining a plurality of components disclosed in the above-described embodiment. For example, some components may be omitted from all the components shown in the embodiment. Moreover, the components relating to different embodiments may be appropriately combined.

Additionally, in the above description, although the means for giving the operation input has the multifunction button 2103 provided on the left side of the display panel 2000, the imaging apparatus of this invention can be connected with a digital television receiving apparatus through the external interface 24 with the use of a CEC function including an HDMI device. In this case, the digital television receiving apparatus works as a monitor. Further, a cross key of a remote controller for operating the relevant digital television receiving apparatus and a multifunction button are used, whereby it is possible to perform the same operation with the multifunction button 2103 on the left side of the display panel 2000.

Further, this invention can be applied to a control method and a program for executing this control method, and further, can be applied to a storage medium in which this program is stored.

Namely, the imaging apparatus of this invention has an image data processor for processing obtained image data which has been obtained in an image taking part, a display part for displaying image data for display which has been processed in the image data processor, a storage part for storing image data for storage which has been processed in the image data processor, and a controller for controlling the image taking part, the image data processor, the display part, and the storage part.

Here, a method for controlling the imaging apparatus of this invention has the steps of: displaying a curved band-like image, which is a part of a ring shape, in a left side region of the display part; displaying a menu-type identification icon image for identification of the present menu as a taking menu, a reproduction menu, or a set-up menu in an inside region, which is provided on the left side of the curved band-like image; and arranging a plurality of menu item icon images, which correspond to the menu identification icon image being displayed, and icon image for set-up on the curved band-like image.

The meaning of the menu item icon image is displayed in an outside region, which is provided on the right side of the curved band-like image, so as to be corresponded to the menu item icon image.

The display part includes a display panel. A jog dial for giving an operation input is provided at the center of the side of the left side of the display panel. A menu button is provided above the jog dial. When the menu button is pushed in the reproducing mode, the menu-type identification icon image representing the reproduction menu is displayed in the inside region, which is provided in the left side of the curved band-like image. Meanwhile, when the menu button is pushed in the taking mode, the menu-type identification icon image representing the taking menu is displayed in the inside region, which is provided in the left side of the curved band-like image. Whether in the taking mode or the reproducing mode, the icon image for set-up on the curved band-like image is selected, and then when the multifunction button 2103 is pushed, it is possible to transfer to the set-up menu.

The program for executing the above-described method is included in the characteristics in the present invention, and a medium (memory) in which this program is stored also is included in the characteristics.

While certain embodiments of the inventions have been described, these embodiments have been presented by way of example only, and are not intended to limit the scope of the inventions. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

The various module, processor or controller of the systems described herein can be implemented as software applications, hardware and/or software modules, or components on one of more computers, such as servers. While the various modules are illustrated separately, they may share some or all of the same underlying logic or code.

What is claimed is:

1. An imaging apparatus comprising:
an image data processor configured to process a captured image data from an image capturing module;
a display module configured to display the image data processed for displaying by the image data processor;
a storage device configured to store the image data processed for storing by the image data processor; and
a controller configured to control the image capturing module, the image data processor, the display module, and the storage device,
wherein the controller is configured to control and display an annular segment, and to display a menu-type icon image of a selected menu, either a capturing menu, a reproduction menu, or a set-up menu on a first side of the annular segment, and the controller comprises a menu item display module configured to display a plurality of icon images of menu items comprised in the selected menu and an icon image for a shortcut to the set-up menu on the annular segment

2. The imaging apparatus of claim 1, wherein the menu item display module is configured to display a definition of the icon image of the selected menu item as text on a second side of the annular segment.

3. The imaging apparatus of claim 1, wherein
the display module comprises a display panel, a jog dial configured to accept an operation input from a user provided at a first portion along the end of the display panel, and a menu button provided at a second portion along the end of the display panel; and
the menu item display module is configured to display the menu-type icon image representing the capturing menu provided on the first side of the annular segment when the menu button is activated in a capturing mode.

4. The imaging apparatus of claim 1, wherein
the display module comprises a display panel, a jog dial configured to accept an operation input from a user provided at a first portion along the end of the display panel, and a menu button is provided at a second portion along the end of the display panel; and
the menu item display module is configured to display the menu-type icon image representing the reproduction menu provided on the first side of the annular segment when the menu button is activated in a reproducing mode.

5. The imaging apparatus of claim 1, wherein
the display module comprises a display panel, a jog dial configured to accept an operation input provided at a first portion along the end of the display panel, a menu button provided at a second portion along the end of the display panel, and a multifunction button provided at a third portion along the end of the display panel; and
the set-up menu is configured to be activated when the icon image for the shortcut to the set-up menu in the annular segment is selected and the multifunction button is activated in either the capturing mode or the reproducing mode.

6. A method for controlling an imaging apparatus comprising the steps of:
capturing an image data;
processing the captured image data;
displaying the processed image data on a display module;
storing the processed image data;
controlling the image capturing, the image data processing, the displaying, and the storing;
displaying an annular segment on the display module;
displaying a menu-type icon image of a selected menu as a capturing menu, a reproduction menu, or a set-up menu on a first side of the annular segment; and
displaying a plurality of icon images of menu items comprised in the selected menu, and an icon image for a shortcut to the set-up menu on the annular segment.

7. The method for controlling an imaging apparatus of claim 6, further comprising:
displaying the definition of the menu item icon image as text on a second side of the annular segment.

8. The method for controlling an imaging apparatus of claim 6, further comprising:
accepting an operation input at a jog dial at a first portion along the end of the display panel, and/or a menu button provided at a second portion along the end of the display panel;
displaying the menu-type icon image representing the reproduction menu provided on the first side of the annular segment when the menu button is pushed in a reproduction mode; and
displaying the menu-type icon image representing the capturing menu provided on the first side of the annular segment, when the menu button is activated in a capturing mode; and
displaying the set-up menu when an icon image for the shortcut to the set-up menu on the annular segment is selected and the multifunction button is activated in either the capturing mode or the reproducing mode.
